(19) United States
(12) Patent Application Publication
(10) Pub. No.: US 2025/0088256 A1
(43) Pub. Date: Mar. 13, 2025

(54) USER EQUIPMENT, METHOD OF USER EQUIPMENT, NETWORK NODE, AND METHOD OF NETWORK NODE

(71) Applicant: NEC Corporation, Minato-ku, Tokyo (JP)

(72) Inventor: Ayesha IJAZ, Tokyo (JP)

(73) Assignee: NEC Corporation, Minato-ku, Tokyo (JP)

(21) Appl. No.: 18/580,662

(22) PCT Filed: Jun. 30, 2022
(86) PCT No.: PCT/JP2022/026387

§ 371 Date: Jan. 19, 2024

(30) Foreign Application Priority Data
Jul. 29, 2021 (JP) 2110935.0

(51) Int. Cl. H04B 7/06; H04B 17/318; H04W 24/10; H04W 84/06

(52) U.S. Cl. CPC H04B 7/06952; H04B 7/0626; H04B 17/328; H04W 24/10; H04W 84/06

(57) ABSTRACT

A communication system is disclosed in which a user equipment (UE) communicates using a beam via a non-terrestrial network. The UE receives from a network node via the non-terrestrial network, information identifying a set of at least one candidate beam for beam switching, performs measurements of reference signals transmitted via the at least one candidate beam in the set; initiates the beam switching to a beam in the set based on a result of the measurements; and transmits, to the network node via the non-terrestrial network, an indication for indicating the beam switching.

### TECHNICAL FIELD

The present invention relates to a wireless communication system and devices thereof operating according to the 3rd Generation Partnership Project (3GPP) standards or equivalents or derivatives thereof. The disclosure has particular but not exclusive relevance to improvements relating to beam management in the so-called ‘5G’ (or ‘Next Generation’) systems employing a non-terrestrial portion comprising airborne or spaceborne network nodes.

### BACKGROUND ART

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. End-user communication devices are commonly referred to as User Equipment (UE) which may be operated by a human or comprise automated devices. Such communication devices might be, for example, mobile communication devices such as mobile telephones, smartphones, smart watches, personal digital assistants, laptop/tablet computers, web browsers, e-book readers, connected vehicles, and/or the like. Such mobile (or even generally stationary) devices are typically operated by a user (and hence they are often collectively referred to as user equipment, ‘UE’) although it is also possible to connect Internet of Things (IoT) devices and similar Machine Type Communications (MTC) devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as MTC, IoT/Industrial IoT (IIoT) communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, the ‘NGMN 5G White Paper’ V1.0 by the Next Generation Mobile Networks (NGMN) Alliance, which document is available from https://www.ngmn.org/5g-white-paper.html.

3GPP is also working on specifying an integrated satellite and terrestrial network infrastructure in the context of 4G and 5G. The term Non-Terrestrial Networks (NTN) refers to networks, or segments of networks, that are using an airborne or spaceborne vehicle for transmission. Satellites refer to spaceborne vehicles in Geostationary Earth Orbit (GEO) or in Non-Geostationary Earth Orbit (NGEO) such as Low Earth Orbits (LEO), Medium Earth Orbits (MEO), and Highly Elliptical Orbits (HEO). Airborne vehicles refer to High Altitude Platforms (HAPs) encompassing Unmanned Aircraft Systems (UAS)-including tethered UAS, Lighter than Air UAS and Heavier than Air UAS-all operating quasi-stationary at an altitude typically between 8 and 50 km.

3GPP Technical Report (TR) 38.811 V15.4.0 is a study on New Radio to support such Non-Terrestrial Networks. The study includes, amongst others, NTN deployment scenarios and related system parameters (such as architecture, altitude, orbit etc.) and a description of adaptation of 3GPP channel models for Non-Terrestrial Networks (propagation conditions, mobility, etc.). 3GPP TR 38.821 V16.1.0 provides further details about NTN.

Non-Terrestrial Networks are expected to:
help foster the 5G service roll out in un-served or underserved areas to upgrade the performance of terrestrial networks;
reinforce service reliability by providing service continuity for user equipment or for moving platforms (e.g. passenger vehicles-aircraft, ships, high speed trains, buses);
increase service availability everywhere; especially for critical communications, future railway/maritime/aeronautical communications; and
enable 5G network scalability through the provision of efficient multicast/broadcast resources for data delivery towards the network edges or even directly to the user equipment.

NTN access typically features the following elements (amongst others):
NTN Terminal: It may refer to a 3GPP UE or a terminal specific to the satellite system in case the satellite doesn't serve directly 3GPP UEs.
A service link which refer to the radio link between the user equipment and the space/airborne platform (which may be in addition to a radio link with a terrestrial based RAN).
A space or an airborne platform.
Gateways ('NTN Gateways') that connect the satellite or aerial access network to the core network. It will be appreciated that gateways will mostly likely be co-located with a base station.
Feeder links which refer to the radio links between the gateways and the space/airborne platform.

Satellite or aerial vehicles may generate several beams over a given area to provide respective NTN cells. The beams have a typically elliptic footprint on the surface of the Earth.

3GPP intends to support three types of NTN beams or cells:
Earth-fixed cells characterized by beam(s) covering the same geographical areas all the time (e.g. GEO satellites and HAPS);
quasi-Earth-fixed cells characterized by beam(s) covering one geographic area for a finite period and a different geographic area during another period (e.g. NGEO satellites generating steerable beams); and
Earth-moving cells characterized by beam(s) covering one geographic area at one instant and a different geographic area at another instant (e.g. NGEO satellites generating fixed or non-steerable beams).

With satellite or aerial vehicle keeping position fixed in terms of elevation/azimuth with respect to a given earth point e.g. GEO and UAS, the beam footprint is earth fixed.

With satellite circulating around the earth (e.g. LEO) or on an elliptical orbit around the earth (e.g. HEO) the beam footprint may be moving over the Earth with the satellite or aerial vehicle motion on its orbit. Alternatively, the beam footprint may be Earth-fixed (or quasi-Earth-fixed) temporarily, in which case an appropriate beam pointing mechanism (mechanical or electronic steering) may be used to compensate for the satellite or aerial vehicle motion.

LEO satellites may have steerable beams in which case the beams are temporarily directed to substantially fixed footprints on the Earth. In other words, the beam footprints (which represent NTN cell) are stationary on the ground for a certain amount of time before they change their focus area over to another NTN cell (due to the satellite's movement on its orbit). From cell coverage/UE point of view, this results in cell changes happening regularly at discrete intervals because different Physical Cell Identities (PCIs) and/or Synchronization Signal/Physical Broadcast Channel (PBCH) blocks (SSBs) have to be assigned after each service link change, even when these beams serve the same land area (have the same footprint). LEO satellites without steerable beams cause the beams (cells) moving on the ground constantly in a sweeping motion as the satellite moves along its orbit and as in the case of steerable beams, service link change and consequently cell changes happen regularly at discrete intervals. Similarly to service link changes, feeder link changes also happen at regular intervals due to the satellite's movement on its orbit. Both service and feeder link changes may be performed between different base stations/gateways (which may be referred to as an ‘inter-gNB radio link switch’) or within the same base station/gateway ('intra-gNB radio link switch').

3GPP is working on specifying enhancements for beam management and Bandwidth Parts (BWP) operation for NTN. Beam level mobility (or ‘beam switching’) is dealt with at lower layers (PHY and MAC) without triggering additional Radio Resource Control (RRC) signaling overhead associated with the conventional handover procedure. Therefore, 3GPP prefers UE connected mode mobility over handover based mobility at least in case of multi-beam Earth moving cells. The currently proposed beam level mobility mechanism involves periodic Channel State Information Reference Signal (CSI-RS) transmissions by the base station and associated measurement reporting by the UE, especially in case of frequent beam switching. Issues related to beam switching have been extensively discussed in 3GPP meetings, however, no conclusions or agreements have been reached.

At least the following issues have been identified with the current measurement-based beam management:
large signaling overhead and long latency for periodic exchange of CSI-RS transmissions and corresponding reporting for NTN; and
increased complexity/power consumption at the UE for performing measurements, particularly for fast moving LEO satellites.

In case of BWP operation for NTN, the following issues also need to be addressed:
appropriate mechanisms such as configured BWP switching may be needed to deal with frequent and relatively predictable satellite beam switching; and
NR BWP switching/beam switching uses UE specific signalling due to UE movement which is inefficient in the NTN scenario where a satellite BWP/beam switching is common for set of UEs (served by the same satellite).

### SUMMARY OF INVENTION

### Solution to Problem

Accordingly, the present invention seeks to provide methods and associated apparatus that address or at least alleviate (at least some of) the above described issues, in particular, to reduce/optimise any signaling overhead and measurement efforts at the UE side.

In one aspect, the invention provides a method performed by a user equipment (UE) configured to communicate using a beam via a non-terrestrial network, the method comprising: receiving, from a network node via the non-terrestrial network, information identifying a set of at least one candidate beam for beam switching; performing measurements of reference signals transmitted via the at least one candidate beam in the set; initiating the beam switching to a beam in the set based on a result of the measurements; and transmitting, to the network node via the non-terrestrial network, an indication for indicating the beam switching.

In one aspect, the invention provides a method performed by a network node configured to communicate with a user equipment (UE) using a beam via a non-terrestrial network, the method comprising: transmitting, to the UE, information identifying a set of at least one candidate beam for beam switching; and receiving an indication from the UE in a case where the UE initiates the beam switching to a beam in the set based on a result of measurements of reference signals transmitted via the at least one candidate beam in the set.

In one aspect, the invention provides a user equipment (UE) configured to communicate using a beam via a non-terrestrial network, the UE comprising: means for receiving, from a network node via the non-terrestrial network, information identifying a set of at least one candidate beam for beam switching; means for performing measurements of reference signals transmitted via the at least one candidate beam in the set; means for initiating the beam switching to a beam in the set based on a result of the measurements; and means for transmitting, to the network node via the non-terrestrial network, an indication for indicating the beam switching.

In one aspect, the invention provides a network node configured to communicate with a user equipment (UE) using a beam via a non-terrestrial network, the network node comprising: means for transmitting, to the UE, information identifying a set of at least one candidate beam for beam switching; and means for receiving an indication from the UE in a case where the UE initiates the beam switching to a beam in the set based on a result of measurements of reference signals transmitted via the at least one candidate beam in the set.

### Advantageous Effects of Invention

Although for efficiency of understanding for those of skill in the art, the invention will be described in detail in the context of a 3GPP system (5G networks including NTN), the principles of the invention can be applied to other systems as well.

Aspects of the invention extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the invention independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Embodiments of the invention will now be described, by way of example, with reference to the accompanying drawings in which:

FIG. 1 illustrates schematically a mobile (cellular or wireless) telecommunication system to which embodiments of the invention may be applied;

FIG. 2 is a schematic block diagram of a mobile device forming part of the system shown in FIG. 1;

FIG. 3 is a schematic block diagram of an NTN node (e.g. satellite/UAS platform) forming part of the system shown in FIG. 1;

FIG. 4 is a schematic block diagram of an access network node (e.g. base station) forming part of the system shown in FIG. 1;

FIG. 5 illustrates schematically an exemplary scenario in which the present invention may be applied; and

FIG. 6 illustrates schematically some exemplary architecture options for the provision of NTN features in the system shown in FIG. 1.

### DESCRIPTION OF EMBODIMENTS

### Overview

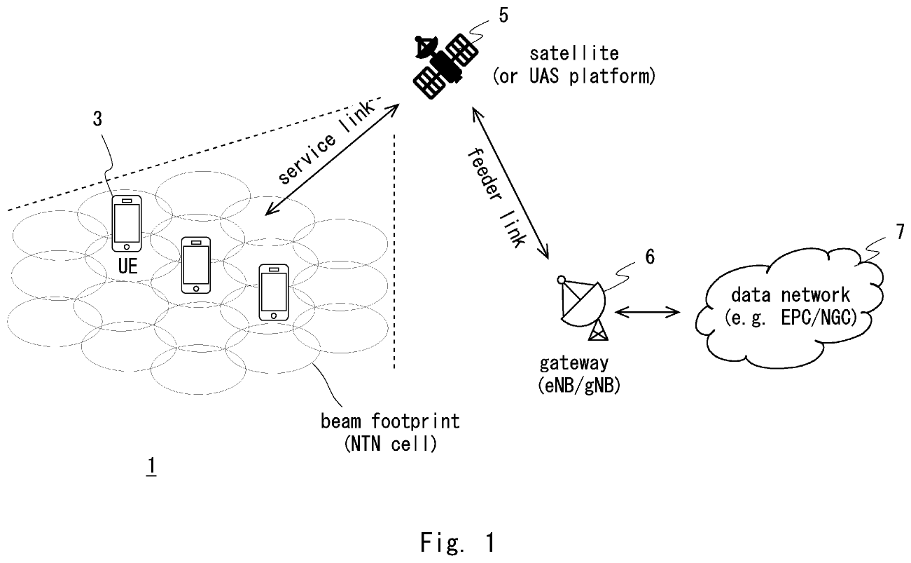

FIG. 1 illustrates schematically a mobile (cellular or wireless) telecommunication system 1 to which embodiments of the invention may be applied.

In this system 1, users of mobile devices 3 (UEs) can communicate with each other and other users via access network nodes respective satellites 5 and/or base stations 6 and a data network 7 using an appropriate 3GPP radio access technology (RAT), for example, an Evolved Universal Terrestrial Radio Access (E-UTRA) and/or 5G RAT. As those skilled in the art will appreciate, whilst three mobile devices 3, one satellite 5, and one base station 6 are shown in FIG. 1 for illustration purposes, the system, when implemented, will typically include other satellites/UAS platforms, base stations/RAN nodes, and mobile devices (UEs).

It will be appreciated that a number of base stations 6 form a (radio) access network or (R) AN, and a number of NTN nodes 5 (satellites and/or UAS platforms) form a Non-Terrestrial Network (NTN). Each NTN node 5 is connected to an appropriate gateway (in this case co-located with a base station 6) using a so-called feeder link and connected to respective UEs 3 via corresponding service links. Thus, when served by an NTN node 5, a mobile device 3 communicates data to and from a base station 6 via the NTN node 5, using an appropriate service link (between the mobile device 3 and the NTN node 5) and a feeder link (between the NTN node 5 and the gateway/base station 6). In other words, the NTN forms part of the (R) AN, although it may also provide satellite communication services independently of E-UTRA (or ‘4G’) and/or New Radio (or ‘5G’) communication services.

Although not shown in FIG. 1, neighbouring base stations 6 are connected to each other via an appropriate base station to base station interface (such as the so-called ‘X2’ interface, ‘Xn’ interface and/or the like). The base station 6 is also connected to the data network nodes via an appropriate interface (such as the so-called ‘S1’, ‘NG-C’, ‘NG-U’ interface, and/or the like).

The data (or core) network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the data network 7 of a ‘Next Generation’/5G system will include user plane entities and control plane entities, such as one or more control plane functions (CPFs) and one or more user plane functions (UPFs). The so-called Access and Mobility Management Function (AMF) in 5G, or the Mobility Management Entity (MME) in 4G, is responsible for handling connection and mobility management tasks for the mobile devices 3. The data network 7 is also coupled to other data networks such as the Internet or similar Internet Protocol (IP) based networks (not shown in FIG. 1).

Each NTN node 5 controls a number of directional beams via which associated NTN cells may be provided. Specifically, each beam has an associated footprint on the surface of the Earth which corresponds to an NTN cell. Each NTN cell (beam) has an associated Physical Cell Identity (PCI) and/or beam identity. The beam footprints may be moving as the NTN node 5 is travelling along its orbit. Alternatively, the beam footprint may be earth fixed, in which case an appropriate beam pointing mechanism (mechanical or electronic steering) may be used to compensate for the movement of the NTN node 5.

Each cell has an associated ‘NR Cell Global Identifier’ (NCGI) to identify the cell globally. The NCGI is constructed from the Public Land Mobile Network (PLMN) identity (PLMN ID) the cell belongs to and the NR Cell Identity (NCI) of the cell. The PLMN ID included in the NCGI is the first PLMN ID within the set of PLMN IDs associated to the NR Cell Identity in System Information Block Type 1 (SIB1). The ‘gNB Identifier’ (gNB ID) is used to identify a particular gNB within a PLMN. The gNB ID is contained within the NCI of its cells. The ‘Global gNB ID’ is used to identify a gNB globally and it is constructed from the PLMN identity the gNB belongs to and the gNB ID. The Mobile Country Code (MCC) and Mobile Network Code (MNC) are the same as included in the NCGI.

When the UE 3 initially establishes an RRC connection with a base station 6 via a cell it registers with an appropriate AMF 9 (or MME). The UE 3 is in the so-called RRC connected state and an associated UE context is maintained by the network.

When the UE 3 is served via the NTN node 5, it receives and transmits data via one of the beams (NTN cells) of the NTN node 5. Over time, due to movement of the UE 3 and/or movement of the serving NTN node 5, the UE 3 switches from beam to beam using appropriate mobility procedures. In order to do so, the base station 6 provides the UE 3 appropriate configuration data and/or assistance information based on which the UE 3 can determine which beam to use and when to switch from one beam to another.

In this system 1, beam level mobility (or ‘beam switching’) is handled at lower layers (at the Physical (PHY) and Medium Access Control (MAC) layers), without requiring additional RRC signaling for each beam switching. Beam level mobility is based on periodic Channel State Information Reference Signal (CSI-RS) transmissions in each cell (by the base station 6, via the NTN node 5), taking into account any assistance information and configuration provided by the network (e.g. when the UE 3 established or reconfigured its RRC connection).

In order to allow efficient beam switching (requiring reduced/optimised measurement efforts at the UE 3) whilst still retaining some control over beam selection, nodes of this system 1 are configured as follows:
the base station 6/NTN node 5 assign mutually exclusive CSI-RS resources to neighboring beams;
the base station 6/NTN node 5 configure appropriate resource sets with possible combinations of candidate CSI-RS resources depending on the beam layout;
the base station 6 indicates a set of candidate beams for measurement and beam switching for the UE 3;
the base station 6/NTN node 5 transmit appropriate assistance information that includes any information necessary for the UE 3 to perform measurements on candidate beams; and
the UE 3 indicates to the base station 6 the beam selected for switching based on the results of measurement of the candidate beams from the configured CSI-RS set(s).

In more detail, the UE 3 performs measurements on candidate beams for beam selection and initiates beam switching only if the quality of a reference signal in the current beam is below a certain threshold and the UE 3 has determined that it is within (or it is approaching) a coverage region of another beam based on the resource set being measured. The UE 3 indicates the strongest beam (i.e. the best candidate for switching) to the base station 6, based on the measurements performed on reference signals transmitted via that beam (and any other beams in the candidate set).

The UE 3 monitors whether certain conditions are met (or at least one condition is met) before triggering a beam indication towards the base station 6. For example, the conditions may include, although not limited to, the Reference Signal Received Power (RSRP) of a candidate beam being higher by a predetermined value than the RSRP of the serving beam (or the RSRP of a candidate beam being equal to or higher than a threshold value). The predetermined value may be given as ‘X’ dB and the value of X can be configured by the base station 6. The UE 3 is configured to transmit an appropriate indication identifying the selected beam via Layer 1 (L1) or the MAC layer (alternatively, using RRC signalling, if appropriate).

Beneficially, the above approach reduces/optimises any signalling overhead and measurement efforts at the UE side without introducing any unnecessary overhead (such as RRC signalling associated with conventional handover). However, the network/base station is able to control the measurement/beam switching process by setting the appropriate candidate beams and by providing assistance information (e.g. value of X) to be taken into account by the UE. The network (base station/AMF/MME) is able to track the beam currently used by the UE based on the indication from the UE when it performs beam switching.

### User Equipment (UE)

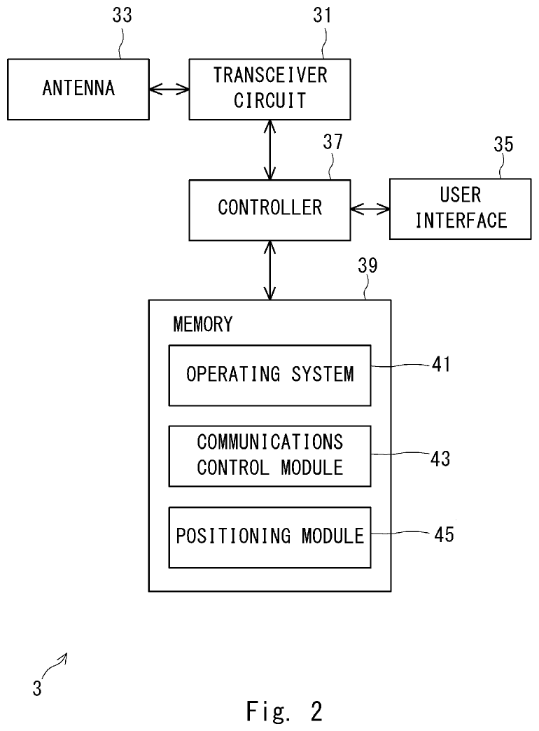

FIG. 2 is a block diagram illustrating the main components of the mobile device (UE) 3 shown in FIG. 1. As shown, the UE 3 includes a transceiver circuit 31 which is operable to transmit signals to and to receive signals from the connected node(s) via one or more antenna 33. Although not necessarily shown in FIG. 2, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43, and a positioning module 45 (which is optional in some UEs).

The communications control module 43 is responsible for handling (generating/sending/receiving) signalling messages and uplink/downlink data packets between the UE 3 and other nodes, including NTN nodes 5, (R) AN nodes 6, and core network nodes. Although not shown in FIG. 2, the communications control module 43 has appropriate sub-modules for the PHY, MAC, and RRC layers, amongst others. The signalling may comprise control signalling (such as RRC signalling) related to configuring and assisting beam level mobility for the UE 3.

If present, the positioning module 45 is responsible for determining the position of the UE 3, for example based on Global Navigation Satellite System (GNSS) signals.

### NTN Node (Satellite/UAS Platform)

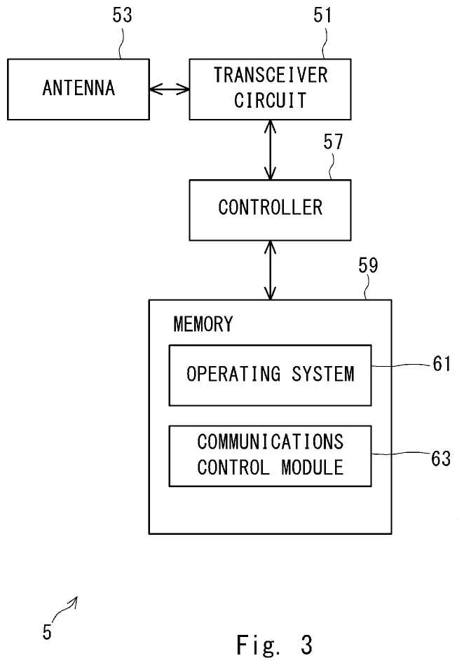

FIG. 3 is a block diagram illustrating the main components of the NTN node 5 (a satellite or a UAS platform) shown in FIG. 1. As shown, the NTN node 5 includes a transceiver circuit 51 which is operable to transmit signals to and to receive signals from connected UE(s) 3 via one or more antenna 53 and to transmit signals to and to receive signals from other network nodes such as gateways and base stations (either directly or indirectly). A controller 57 controls the operation of the NTN node 5 in accordance with software stored in a memory 59. The software may be pre-installed in the memory 59 and/or may be downloaded via the telecommunication network 1 or from a removable data storage device (RMD), for example. The software includes, among other things, an operating system 61, and a communications control module 63.

The communications control module 63 is responsible for handling (generating/sending/receiving/relaying) signalling between the NTN node 5 and other nodes, such as the UE 3, base stations 6, gateways, and core network nodes (via the base stations/gateways). The signalling may comprise control signalling (such as RRC signalling) related to configuring and assisting beam level mobility for the UE 3.

### Base Station/Gateway (Access Network Node)

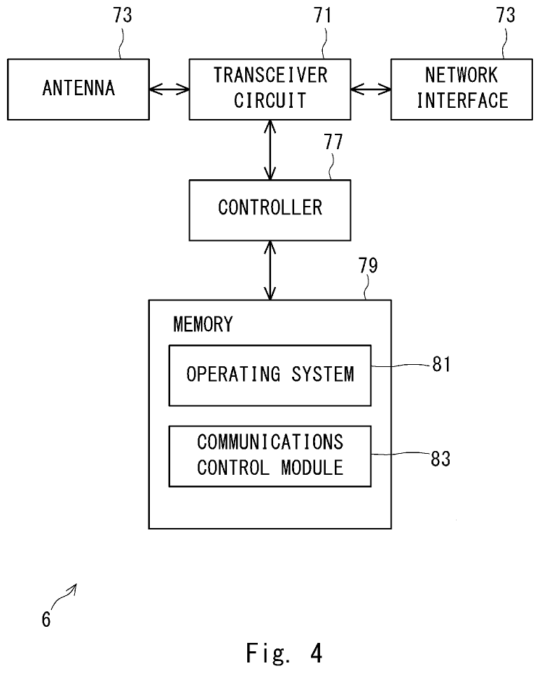

FIG. 4 is a block diagram illustrating the main components of the gateway 6 shown in FIG. 1 (a base station (gNB) or a similar access network node). As shown, the gateway/gNB 6 includes a transceiver circuit 71 which is operable to transmit signals to and to receive signals from connected UE(s) 3 via one or more antenna 73 and to transmit signals to and to receive signals from other network nodes (either directly or indirectly) via a network interface 75. Signals may be transmitted to and received from the UE(s) 3 either directly and/or via the NTN node 5, as appropriate. The network interface 75 typically includes an appropriate base station-base station interface (such as X2/Xn) and an appropriate base station-core network interface (such as S1/NG-C/NG-U). A controller 77 controls the operation of the base station 6 in accordance with software stored in a memory 79. The software may be pre-installed in the memory 79 and/or may be downloaded via the telecommunication network 1 or from a removable data storage device (RMD), for example. The software includes, among other things, an operating system 81, and a communications control module 83.

The communications control module 83 is responsible for handling (generating/sending/receiving) signalling between the base station 6 and other nodes, such as the UE 3, NTN nodes 5, and core network nodes. Although not shown in FIG. 4, the communications control module 83 has appropriate sub-modules for the PHY, MAC, and RRC layers, amongst others. The signalling may comprise control signalling (such as RRC signalling) related to configuring and assisting beam level mobility for the UE 3.

### Detailed Description

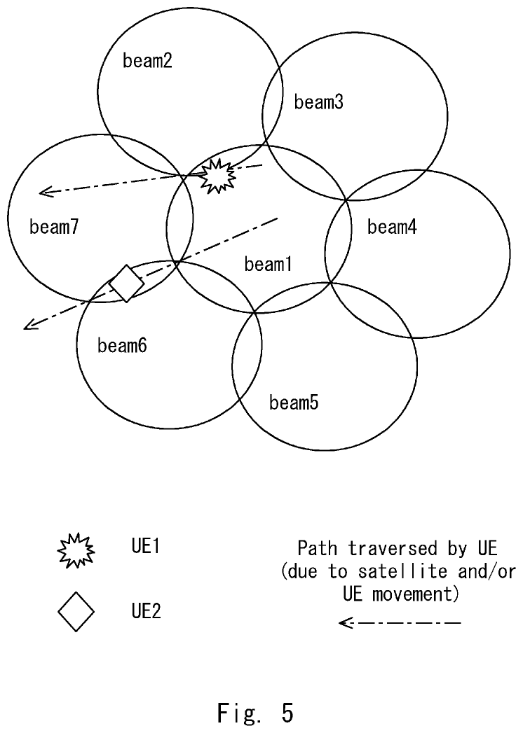

The following is a description of an exemplary procedure performed by the nodes of the system shown in FIG. 1, with reference to the exemplary scenario shown in FIG. 5. As can be seen, FIG. 5 illustrates a cluster of seven beams (NTN cells) and two UEs moving relative to the cluster of beams. It will be appreciated that the same scenario is applicable to stationary UEs as well in which case the beams are moving relative to the UEs (or the scenario in which both the beams and the UEs are moving).

The following procedure benefits from the predictability of beam switching (such as the expected timing of switching and possible candidate cells) either by the base station 6 or the UE 3 in order to reduce signalling overhead and measurement efforts at the UE 3. In addition, the following procedure also considers the channel condition for the UE 3.

In more detail, the network (base station 6, using its communication control module 83) configures different CSI-RS resources for different beams in the satellite footprint. All beams surrounding a particular beam are assigned mutually exclusive CSI-RS resources. For example, the CSI-RS resources assigned to the seven beams in FIG. 5 are not shared among the beams in this cluster (however, they may be shared with beams in another clusters of beams).

Note that ‘beam1’ to ‘beam7’ in FIG. 5 does not indicate actual beam numbers or beam indices used by the satellite 5. However, in the present description, for a given UE 3, beam1 denotes the UE's serving beam and beam2 to beam7 are logical indices of surrounding beams in corresponding directions. Although the serving beam is shown to have six neighbour beams in FIG. 5 for illustration purposes, it will be appreciated that, depending on the beam footprints and any relevant network parameter or geographical aspect, a beam may have a different number of neighbours (i.e. more than six neighbour beams or less than six neighbour beams).

The base station 6 (using its communication control module 83) transmits assistance information to the UEs 3 for determining a (respective) candidate beam that they may switch to when they reach the edge of their current serving beam. The assistance information in this case includes any information that a UE 3 needs for performing measurements on each candidate beam (and the serving beam if applicable).

For example, the assistance information may be sent via an appropriately formatted MAC Control Element (MAC-CE) scheduled via a Downlink Control Information (DCI) that is common to a group of UEs (which may be a beam specific DCI for all UEs in a given beam or a cluster of beams). The assistance information in this case is related to the candidate beams surrounding the current beam and it may be used by all UEs served by that beam. Alternatively, UE specific DCI/MAC-CE may also be used, if appropriate, to assistance information to a particular UE. Such UE specific assistance information may be appropriate depending on the number of UEs served by a given beam (e.g. when there are a relatively small number of UEs) and/or depending on movement of a particular UE relative to the serving beam (e.g. for a fast moving UE, a stationary UE, or UE moving in a different direction to other UEs served by the same beam).

In another example, the relevant assistance information may be applicable to all beams (or a subset of all beams) of a satellite 5 and it may be sent to all UEs 3 served by that satellite 5. For example, the assistance information may be broadcast in system information to allow a UE 3 in any serving beam to acquire the necessary information for performing measurements on its surrounding beams (beam switching candidates).

It will be appreciated that the CSI-RS resource sets may be defined so that based on its associated resource set(s) a UE 3 can determine what measurements it needs to perform for beam switching and it can also determine any target candidate beam. The applicable resource sets may be configured via RRC signalling or broadcast in system information (per UE, or for a group of UEs).

For example, referring to the beam layout in FIG. 5, the following CSI-RS resource sets may be defined:

Set A = {CSI-RS Resource Beam 1, CSI-RS Resource Beam 2, CSI-RS Resource Beam 3}
Set B = {CSI-RS Resource Beam 1, CSI-RS Resource Beam 3, CSI-RS Resource Beam 4}
Set C = {CSI-RS Resource Beam 1, CSI-RS Resource Beam 4, CSI-RS Resource Beam 5}
Set D = {CSI-RS Resource Beam 1, CSI-RS Resource Beam 5, CSI-RS Resource Beam 6}
Set E = {CSI-RS Resource Beam 1, CSI-RS Resource Beam 6, CSI-RS Resource Beam 7}
Set F = {CSI-RS Resource Beam 1, CSI-RS Resource Beam 7, CSI-RS Resource Beam 2}
Set G = {CSI-RS Resource Beam 1}
Set H = {CSI-RS Resource Beam 1, CSI-RS Resource Beam 2}
Set I = {CSI-RS Resource Beam 1, CSI-RS Resource Beam 3}
Set J = {CSI-RS Resource Beam 1, CSI-RS Resource Beam 4}
Set K = {CSI-RS Resource Beam 1, CSI-RS Resource Beam 5}
Set L = {CSI-RS Resource Beam 1, CSI-RS Resource Beam 6}
Set M = {CSI-RS Resource Beam 1, CSI-RS Resource Beam 7}
where “CSI-RS Resource Beam X” denotes CSI-RS resources configured for measurement
of quality/strength of the beam with logical index ‘X’.

The base station 6 indicates to each UE 3 the candidate beams for switching, for example by transmitting information identifying the resource set to be used by that UE 3 for its signal measurements.

Using the exemplary resource sets in the above table, if the base station 6 configures ‘UE1’ of FIG. 5 with resource set F, that UE can determine that its candidate beams for beam switching include the ones denoted ‘beam2’ and ‘beam7’. UE1 can also determine that it does not need to perform measurements on reference signals transmitted via the beams denoted ‘beam3’, ‘beam4’, ‘beam5’, and ‘beam6’ because they are not included in the set of candidate beams. Alternatively, the base station 6 may configure ‘UE1’ with resource set M, in which case the UE can determine that it needs to measure ‘beam7’ only (in addition to its current serving beam, i.e. ‘beam1’ in FIG. 5).

Using the example of ‘UE2’ of FIG. 5, the base station 6 may configure this UE with resource set E, in which case the candidate beams for that UE include ‘beam6’ and ‘beam7’. UE2 can also determine that it does not need to perform measurements on reference signals transmitted via the beams denoted ‘beam2’, ‘beam3’, ‘beam4’, and ‘beam5’ because they are not included in the set of candidate beams for that UE. Alternatively, the base station 6 may configure ‘UE2’ with resource set M, in which case the UE can determine that it needs to measure ‘beam7’ only (in addition to its current serving beam, i.e. ‘beam1’ in FIG. 5).

It will be appreciated that various other options may be possible, for example, a UE 3 can be configured with more than one resource sets (e.g. by signalling sets K, L, and M the base station 6 can configure ‘beam5’, ‘beam6’, and ‘beam7’ as the candidate beams for a given UE 3). This approach may be beneficial for example when movement of the UE 3 is less predictable in which case it may be beneficial to configure a relatively larger number of candidate beams.

Once the UE 3 has obtained information identifying its candidate beams, the UE 3 performs measurement on those beams for beam selection and switching. In a particularly beneficial example, the UE 3 performs signal measurement on the candidate beams only if the quality of a reference signal (or signals) in the UE's current serving beam is below a certain threshold and the UE has determined that it is substantially within (or it is approaching) the coverage region of another beam (from among the set of candidate beams). The result of the signal measurements (CSI-RS measurements) for a given beam may be given as an RSRP value (in dB) of that beam.

Based on the result of the signal measurements, the UE 3 indicates the strongest beam (e.g. the beam with the highest RSRP) to the base station 6 as the beam selected by the UE 3 for beam switching. The UE 3 may be configured to transmit an appropriate indication identifying the strongest/selected beam via Layer 1 (L1) or via the MAC layer (alternatively, using RRC signalling, if appropriate).

The UE 3 may indicate the selected beam upon switching to that beam (e.g. immediately prior to switching or upon completion of switching) so that the base station 6 can record (and confirm, if appropriate) that the UE 3 is served by a new beam. Alternatively, the UE 3 may indicate the selected beam before initiating beam switching in which case the base station 6 may be configured to transmit an appropriate indication whether or not the UE 3 is allowed to switch to that beam. However, it will be appreciated that such explicit approval from the base station 6 may not be needed at least in the case when the UE 3 is configured with a specific set of candidate beams.

In any case, this approach may result in reduced overhead as the measurement report(s) for each candidate beam do not need to be sent to the base station 6 for selection of a suitable new serving beam for the UE 3. Moreover, the beam switching process takes into account the UE's channel condition since the beam switching decision (beam selection) is based on measurement of signals from candidate beams in the candidate CSI-RS set(s) configured for the UE 3.

Beneficially, an appropriate beam indication may be triggered by the UE 3 upon meeting certain predetermined condition(s). Such conditions may include, although they are not limited to, the RSRP of a candidate beam being higher by a predetermined value than a threshold value or the RSRP of the serving beam. The predetermined value may be given as ‘X’ dB and the value of X may be configured by the base station 6 (per UE or per beam).

### Benefits

Beneficially, the above approach reduces/optimises any signalling overhead and measurement efforts at the UE side without introducing any unnecessary overhead (such as RRC signalling associated with conventional handover). This is achieved by configuring the UE to perform measurements for specific candidate beams (which are selected and signalled by the base station via appropriate resource set indication) and to indicate the selected/best beam when the UE needs to perform beam switching. This also reduces overhead as the measurement report does not need to be sent to the base station (only the switching indication). However, the beam switching procedure takes into account the UE's channel condition since the beam switching decision is still based on measurement(s) of signal(s) from the candidate beam(s).

Another benefit is that the network/base station is able to control the measurement/beam switching process by setting the appropriate candidate beams and by providing assistance information (e.g. value of X) to be taken into account by the UE. The network (base station/AMF/MME) is able to track the beam currently used by the UE based on the indication from the UE when it performs beam switching.

This approach avoids switching decision made purely by the UE based on RSRP measurements which may lead to an undesirable result (at least from the network point of view) and may waste measurement effort at the UE in case the UE needs to reselect to another beam. Since the base station is aware of the UE movements (and/or the movement of the beams), it can reduce measurement effort and switching frequency by indicating an appropriate resource set to the UEs.

### Modifications and Alternatives

Detailed embodiments have been described above. As those skilled in the art will appreciate, a number of modifications and alternatives can be made to the above embodiments whilst still benefiting from the inventions embodied therein. By way of illustration only a number of these alternatives and modifications will now be described.

The assistance information may include information identifying the beam layout or information from which the beam layout may be derived by the UE. Such information may include, although not limited to, information relating to beam width, information identifying the applicable BWP(s)/beam, information identifying the centre elevation and/or azimuth of a beam, etc. However, it will be appreciated that the assistance information does not necessarily need to include such beam layout information. Instead, the assistance information may include information identifying any preconfigured resources and/or an indication of candidate resources (as shown in the above table) for a given UE (or a group of UEs). In this case the assistance information only needs to include beam specific parameters which are necessary for a UE (or group of UEs) to perform measurements on the appropriate candidate beams. Due to the base station's control over candidate beam indication, it can select and indicate appropriate candidate beams for each UE for load balancing purposes or for interference coordination (with respect to beams/cell controlled by a given base station or beams/cells controlled by neighbouring base stations). For example, in the scenario shown in FIG. 5, when UE2 is located at the edge of ‘beam1’ or within the overlapping region between ‘beam6’ and ‘beam7’, the base station may be able to select a specific target beam (e.g. ‘beam6’) for UE2 that is more suitable for e.g. load balancing and/or interference coordination.

Whilst a base station of a 5G/NR communication system is commonly referred to as a New Radio Base Station ('NR-BS') or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP Technical Specification (TS) 38.300 V16.6.0 and TS 37.340 V16.6.0 define the following nodes, amongst others:

gNB: node providing NR user plane and control plane protocol terminations towards the UE, and connected via the NG interface to the 5G core network (5GC).

gNB: node providing NR user plane and control plane protocol terminations towards the UE, and connected via the NG interface to the 5G core network (5GC).

En-gNB: node providing NR user plane and control plane protocol terminations towards the UE, and acting as Secondary Node in E-UTRA-NR Dual Connectivity (EN-DC).

NG-RAN node: either a gNB or an ng-eNB.

It will be appreciated that the above embodiments may be applied to both 5G New Radio and LTE systems (E-UTRAN). A base station (gateway) that supports E-UTRA/4G protocols may be referred to as an ‘eNB’ and a base station that supports Next Generation/5G protocols may be referred to as a ‘gNBs’. It will be appreciated that some base stations may be configured to support both 4G and 5G protocols, and/or any other 3GPP or non-3GPP communication protocols.

TABLE 1
types of satellites and UAS platforms

| | | | | Typical beam | |
|---|---|---|---|---|---|
| Platforms | Altitude range | | Orbit | footprint size | |
| Low-Earth Orbit | 300-1500 | km | Circular around the | 100-1000 | km |
| (LEO) satellite | | | earth | | |
| Medium-Earth Orbit | 7000-25000 | km | | 100-1000 | km |
| (MEO) satellite | | | | | |
| Geostationary Earth | 35 786 | km | Notional station keeping | 200-3500 | km |
| Orbit (GEO) satellite | | | position fixed in terms | | |
| UAS platform | 8-50 km | | of elevation/azimuth | 5-200 | km |
| (including HAPS) | (20 km for HAPS) | | with respect to a given | | |
| High Elliptical Orbit | 400-50000 | km | earth point | 200-3500 | km |
| (HEO) satellite | | | Elliptical around the | | |
| | | | earth | | |

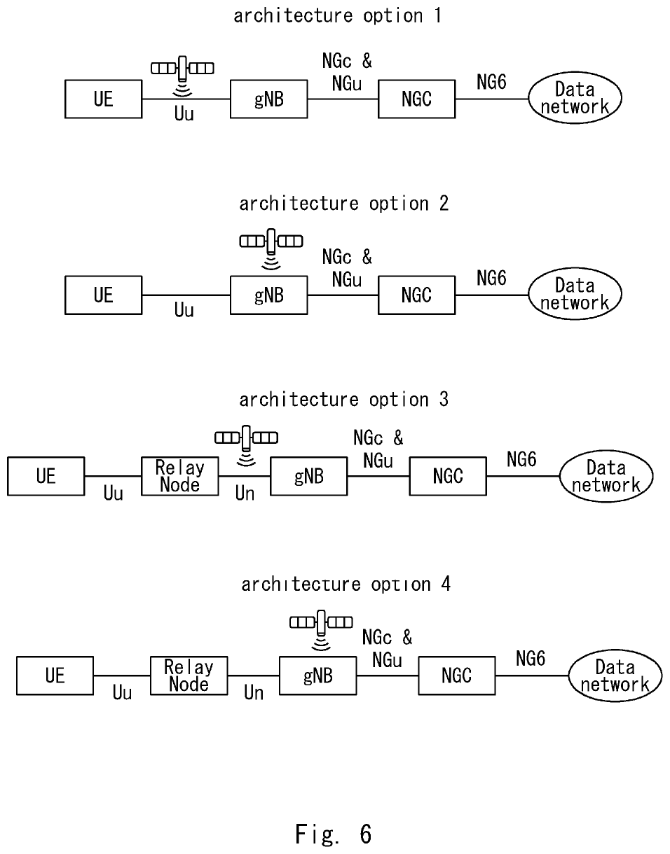

It will be appreciated that there are various architecture options to implement NTN in a 5G system, some of which are illustrated schematically in FIG. 6. The first option shown is an NTN featuring an access network serving UEs and based on a satellite/aerial with bent pipe payload and gNB on the ground (satellite hub or gateway level). The second option is an NTN featuring an access network serving UEs and based on a satellite/aerial with gNB on board. The third option is an NTN featuring an access network serving Relay Nodes and based on a satellite/aerial with bent pipe payload. The fourth option is an NTN featuring an access network serving Relay Nodes and based on a satellite/aerial with gNB. It will be appreciated that other architecture options may also be used, for example, a combination of two or more of the above described options. Alternatively, the relay node may comprise a satellite/UAS. It will be appreciated that similar architecture options may be used in 4G/LTE systems as well, but with an eNB instead of the gNB, an EPC instead of NGC, and using the appropriate LTE interfaces instead of the NG interfaces shown in FIG. 6.

In the above description, the UE, the NTN node (satellite/UAS platform), and the access network node (base station) are described for ease of understanding as having a number of discrete modules (such as the communication control modules). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above embodiments, a number of software modules were described. As those skilled in the art will appreciate, the software modules may be provided in compiled or un-compiled form and may be supplied to the UE, the NTN node, and the access network node (base station) as a signal over a computer network, or on a recording medium. Further, the functionality performed by part or all of this software may be performed using one or more dedicated hardware circuits. However, the use of software modules is preferred as it facilitates the updating of the UE, the NTN node, and the access network node (base station) in order to update their functionalities.

The above embodiments are also applicable to ‘non-mobile’ or generally stationary user equipment. The above described mobile device may comprise an MTC/IoT device and/or the like.

The method performed by the UE may comprise receiving, from a network node via the non-terrestrial network, the information identifying the set of at least one candidate beam using at least one of: Radio Resource Control (RRC) signalling (e.g. via an RRC Connection Reconfiguration message); Medium Access Control (MAC) signalling (e.g. via a MAC Control Element scheduled via a Downlink Control Information (DCI) that is common to a group of UEs); and system information (e.g. system information common to all UEs served via a plurality of beams of the non-terrestrial network). The system information may identify respective sets of at least one candidate beam for each of a plurality of possible serving beams.

The method performed by the UE may further comprise receiving assistance information for the measurements of the set of at least one candidate beam (e.g. information identifying a beam layout such as beam width, centre elevation and azimuth and/or information identifying one of a set of preconfigured resources).

Each beam in said set of at least one candidate beam may employ mutually exclusive Channel State Information Reference Signal (CSI-RS) resources to the CSI-RS resources employed by other beams in said set.

The indication may identify the beam that the UE is switching to. The indication may indicate the strongest beam in said set based on the result of said measurements' f. The method performed by the UE may further comprise initiating the beam switching to a beam in the set based on a result of the measurements.

The method performed by the UE may further comprise transmitting, to the network node via the non-terrestrial network, the indication when a Reference Signal Received Power (RSRP) of a candidate beam is higher than an associated threshold value or higher than the RSRP of the serving beam by at least a predetermined value (e.g. a dB value). In this case, the predetermined value may be configured by a base station serving the UE.

The method performed by the UE may further comprise transmitting the indication when a quality of a reference signal in a current serving beam used by the UE is below an associated threshold based on measurements of reference signals transmitted via the current serving beam.

The method performed by the UE may further comprise transmitting the indication via at least one of: Layer 1 (L1) signalling; MAC layer signalling; and RRC signalling.

The method performed by the UE may further comprise receiving, from the serving base station, a response to said indication before initiating said beam switching.

The method performed by the UE may further comprise initiating said beam switching when a quality of at least one reference signal transmitted via the serving beam is below a threshold based on an associated measurement.

The method performed by the UE may comprise initiating beam switching if the UE is determined to be within or substantially within a coverage of another beam based on the result of said measurements.

The method performed by the UE may further comprise initiating said beam switching when a RSRP of a candidate beam is higher than an associated threshold value or higher than the RSRP of the serving beam by at least a predetermined value (e.g. a dB value).

Various other modifications will be apparent to those skilled in the art and will not be described in further detail here.

### CITATION LIST

### Non Patent Literature

[1] 3GPP Technical Report (TR) 38.811 V15.4.0

[2] 3GPP TR 38.821 V16.1.0

[3] 3GPP Technical Specification (TS) 38.300 V16.6.0

[4] 3GPP TS 37.340 V16.6.0

### Patent Literature

[1] US2017/324463A1

Although the present invention has been described with reference to the exemplary embodiments, the present invention is not limited to the above. Various changes that can be understood by those skilled in the art can be made to the configuration and details of the present invention within the scope of the invention.

The program can be stored and provided to the computer device using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to the computer device using any type of transitory computer readable media. Examples of transitory computer readable media include electric signals, optical signals, and electromagnetic waves. Transitory computer readable media can provide the program to the computer device via a wired communication line, such as electric wires and optical fibers, or a wireless communication line.

For example, the whole or part of the exemplary embodiments disclosed above can be described as, but not limited to, the following supplementary notes.

(Supplementary Note 1)

A method performed by a user equipment (UE) configured to communicate using a beam via a non-terrestrial network, the method comprising:
receiving, from a network node via the non-terrestrial network, information identifying a set of at least one candidate beam for beam switching;
performing measurements of reference signals transmitted via the at least one candidate beam in the set;
initiating the beam switching to a beam in the set based on a result of the measurements; and
transmitting, to the network node via the non-terrestrial network, an indication for indicating the beam switching.

(Supplementary Note 2)

The method according to supplementary note 1, wherein the indication identifies the beam.

(Supplementary Note 3)

The method according to supplementary note 1 or 2, wherein the indication indicates the strongest beam in the set based on the result of the measurements.

(Supplementary Note 4)

The method according to any one of supplementary notes 1 to 3, wherein the transmitting the indication is performed in a case where a Reference Signal Received Power (RSRP) of the beam is higher than a threshold value or higher than the RSRP of a current serving beam by at least a parameter value.

(Supplementary Note 5)

The method according to supplementary note 4, wherein the parameter value is configured by a base station serving the UE.

(Supplementary Note 6)

The method according to any one of supplementary notes 1 to 5, wherein the transmitting the indication is performed in a case where a quality of a reference signal in a current serving beam is below a threshold based on measurements of the reference signal.

(Supplementary Note 7)

The method according to any one of supplementary notes 1 to 6, wherein the initiating the beam switching is performed in a case where a quality of a reference signal in a current serving beam is below a threshold based on measurements of the reference signal.

(Supplementary Note 8)

The method according to supplementary note 7, wherein the initiating the beam switching is performed in a case where the UE is determined to be within or substantially within a coverage of another beam in the set based on the result of the measurements.

(Supplementary Note 9)

The method according to any one of supplementary notes 1 to 8, wherein the initiating the beam switching is performed in a case where a RSRP of a candidate beam in the set is higher than a threshold or higher than the RSRP of a current serving beam by at least a parameter value.

(Supplementary Note 10)

The method according to any one of supplementary notes 1 to 9, wherein the receiving is performed by using at least one of:
Radio Resource Control (RRC) signalling;
Medium Access Control (MAC) signalling; and
system information.

(Supplementary Note 11)

The method according to supplementary note 10, wherein the system information identifies respective sets of at least one candidate beam for each of a plurality of possible serving beams.

(Supplementary Note 12)

The method according to any one of supplementary notes 1 to 11, further comprising receiving, from the network node via the non-terrestrial network, assistance information for the measurements of the set of the at least one candidate beam.

(Supplementary Note 13)

The method according to any one of supplementary notes 1 to 12, wherein each beam in the set of the at least one candidate beam employs mutually exclusive Channel State Information Reference Signal (CSI-RS) resources to the CSI-RS resources employed by other beams in the set.

(Supplementary Note 14)

The method according to any one of supplementary notes 1 to 13, wherein the transmitting is performed via at least one of:
Layer 1 (L1) signalling;
MAC layer signalling; and
RRC signalling.

(Supplementary Note 15)

The method according to any one of supplementary notes 1 to 14, further comprising receiving, from the network node via the non-terrestrial network, a response to the indication before initiating the beam switching.

(Supplementary Note 16)

A method performed by a network node configured to communicate with a user equipment (UE) using a beam via a non-terrestrial network, the method comprising:
transmitting, to the UE, information identifying a set of at least one candidate beam for beam switching; and
receiving an indication from the UE in a case where the UE initiates the beam switching to a beam in the set based on a result of measurements of reference signals transmitted via the at least one candidate beam in the set.

(Supplementary Note 17)

A user equipment (UE) configured to communicate using a beam via a non-terrestrial network, the UE comprising:
means for receiving, from a network node via the non-terrestrial network, information identifying a set of at least one candidate beam for beam switching;
means for performing measurements of reference signals transmitted via the at least one candidate beam in the set;
means for initiating the beam switching to a beam in the set based on a result of the measurements; and
means for transmitting, to the network node via the non-terrestrial network, an indication for indicating the beam switching.

(Supplementary Note 18)

A network node configured to communicate with a user equipment (UE) using a beam via a non-terrestrial network, the network node comprising:
means for transmitting, to the UE, information identifying a set of at least one candidate beam for beam switching; and
means for receiving an indication from the UE in a case where the UE initiates the beam switching to a beam in the set based on a result of measurements of reference signals transmitted via the at least one candidate beam in the set.

This application is based upon and claims the benefit of priority from United Kingdom patent application No. 2110935.0, filed on Jul. 29, 2021, the disclosure of which is incorporated herein in its entirety by reference.

### REFERENCE SIGNS LIST

1 communication system
3 user equipment (UE)
5 satellite
6 gateway
7 data network

What is claimed is:

1-18. (canceled)

19. A method performed by a user equipment (UE) configured to communicate via a non-terrestrial network, the method comprising:
receiving, from a network node via the non-terrestrial network, information identifying a set of at least one candidate beam for beam switching, the set of the at least one candidate beam corresponding to a network node in the non-terrestrial network;
performing measurements of reference signals transmitted via the at least one candidate beam in the set;
initiating the beam switching to a beam in the set based on a result of the measurements; and
transmitting, to the network node via the non-terrestrial network, an indication for indicating the beam switching.

20. The method according to claim 19, wherein
each beam in the set of the at least one candidate beam employs mutually exclusive Channel State Information Reference Signal (CSI-RS) resources to the CSI-RS resources employed by other beams in the set.

21. The method according to claim 19, wherein
the set of the at least one candidate beam is configured based on load balancing or interference coordination at the network node.

22. The method according to claim 19, wherein
the initiating the beam switching is performed without transmitting a measurement report regarding the measurements to the network node.

23. The method according to claim 19, wherein
the beam switching is performed taking a channel condition of the UE into account.

24. The method according to claim 19, wherein
the initiating the beam switching is performed in a case where the UE is determined to be within or substantially within a coverage of another beam in the set based on the result of the measurements.

25. The method according to claim 19, wherein
the initiating the beam switching is performed in a case where a quality of a reference signal in a current serving beam is below a threshold based on measurements of the reference signal.

26. The method according to claim 19, wherein
the initiating the beam switching is performed in a case where a Reference Signal Received Power (RSRP) of a candidate beam in the set is higher than a threshold or higher than the RSRP of a current serving beam by at least a parameter value.

27. The method according to claim 19, wherein
the receiving is performed by using at least one of:
Radio Resource Control (RRC) signalling;
Medium Access Control (MAC) signalling; and
system information.

28. The method according to claim 27, wherein
the system information identifies respective sets of at least one candidate beam for each of a plurality of possible serving beams.

29. The method according to claim 19, wherein
the indication identifies the beam.

30. The method according to claim 19, wherein
the indication indicates the strongest beam in the set based on the result of the measurements.

31. The method according to claim 19, wherein
the transmitting the indication is performed in a case where a Reference Signal Received Power (RSRP) of the beam is higher than a threshold value or higher than the RSRP of a current serving beam by at least a parameter value.

32. The method according to claim 31, wherein
the parameter value is configured by a base station serving the UE.

33. The method according to claim 19, wherein
the transmitting the indication is performed in a case where a quality of a reference signal in a current serving beam is below a threshold based on measurements of the reference signal.

34. The method according to claim 19, wherein
the transmitting is performed via at least one of:
Layer 1 (L1) signalling;
MAC layer signalling; and
RRC signalling.

35. The method according to claim 19, further comprising:
receiving, from the network node via the non-terrestrial network, a response to the indication before initiating the beam switching.

36. A method performed by a network node configured to communicate with a user equipment (UE) via a non-terrestrial network, the method comprising:
transmitting, to the UE, information identifying a set of at least one candidate beam for beam switching, the set of the at least one candidate beam corresponding to a movement of a network node in the non-terrestrial network; and
receiving an indication from the UE in a case where the UE initiates the beam switching to a beam in the set based on a result of measurements of reference signals transmitted via the at least one candidate beam in the set.

37. A user equipment (UE) configured to communicate via a non-terrestrial network, the UE comprising:
at least one memory storing instructions; and
at least one processor configured to process the instructions to:
receive, from a network node via the non-terrestrial network, information identifying a set of at least one candidate beam for beam switching, the set of the at least one candidate beam corresponding to a movement of a network node in the non-terrestrial network;
perform measurements of reference signals transmitted via the at least one candidate beam in the set;
initiate the beam switching to a beam in the set based on a result of the measurements; and
transmit, to the network node via the non-terrestrial network, an indication for indicating the beam switching.

38. A network node configured to communicate with a user equipment (UE) via a non-terrestrial network, the network node comprising:
at least one memory storing instructions; and
at least one processor configured to process the instructions to:
transmit, to the UE, information identifying a set of at least one candidate beam for beam switching, the set of the at least one candidate beam corresponding to a movement of a network node in the non-terrestrial network; and
receive an indication from the UE in a case where the UE initiates the beam switching to a beam in the set based on a result of measurements of reference signals transmitted via the at least one candidate beam in the set.
